(19) United States
(12) Patent Application Publication
(10) Pub. No.: US 2007/0031792 A1
(43) Pub. Date: Feb. 8, 2007

(54) Provisional crown for dental implants

(76) Inventors: Kelley Casement, Overland Park, KS (US); Ricardo Gapski, Overland Park, KS (US); Russell Casement, Parker, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/197,743

(22) Filed: Aug. 3, 2005

(51) Int. Cl. A61C 5/08; A61C 8/00

(52) U.S. Cl. 433/218; 433/173

(57) ABSTRACT

The invention relates in general to the fabrication of provisional or temporary crowns utilized to temporarily restore dental implants. The pre-fabricated provisional crowns are designed to specifically mate to the gingival portion of the abutment fixture of a dental implant or the collar of a dental implant. Therefore, the clinician can place the implant alone or in conjunction with a tooth extraction, and may select and place a pre-fabricated provisional crown for that particular implant system in the same appointment. The pre-fabricated provisional implant crown will generally comprise a hollow shell. The shell will be hollow in the interior aspect in order to accommodate implant prosthetic abutment systems.

### BACKGROUND OF THE INVENTION

Implant dentistry has become successful with the discovery of the biological properties of titanium. In the original implant protocol, a two-stage surgical protocol was advocated for load-free and submerged healing to ensure predictable osseointegration. However, the discomfort, inconvenience, and anxiety associated with the load-free waiting period presented significant challenges to both patients and clinicians. Hence, the temporary loading of implants immediately or soon after placement has been attempted and has gained popularity among clinicians. Studies in the area of immediate loading have been proposed and have shown encouraging results. More recently, several studies have demonstrated good success rates of immediate function or loading for single crown replacement. In these case studies, the implant is placed and a provisional crown is prepared at the same appointment in order to maintain the original gingival contour and to maintain patient's esthetics and/or function.

Typically, the endosseous implant is placed alone or in conjunction with tooth extraction, an adequate prosthetic abutment for the selected implant is screwed into the implant, and a provisional crown is fabricated. Subsequently, this provisional crown is temporarily seated. To date, there are three general methods for the fabrication of provisional crowns. The first technique involves utilizing a conventional pre-fabricated crown form or shell made of metal or polycarbonate, which is individually trimmed and shaped to fit a prosthetic abutment using resins, cements, etc. Another technique involves making an impression before the original tooth is extracted and the implant placed. Then the impression is filled with bis-acryl or composite material and placed over the prosthetic abutment. The material sets and is then removed from the dental impression, trimmed, polished and cemented provisionally in the implant prosthetic abutment. The third technique utilizes a putty-like ball of polymethyl-methacrylate that is applied over the implant prosthetic abutment, the patient bites down, and the material begins to set. Before it completely sets, the putty-like material is removed from the tooth, trimmed and placed back on the implant prosthetic abutment.

Each of the known provisional crowns and methods suffer from disadvantages, including complex, individualized, and time consuming preparation; a lack of custom fit to the specific implant abutment in use; and poor gumline or gingival healing. In addition, the known methodologies for placement of provisional crowns are technique sensitive, and thus are subject to variation. Therefore, a need remains for improved provisional implant crowns.

### BRIEF SUMMARY OF THE INVENTION

To address these and other needs, the present invention provides, in part, a pre-fabricated implant provisional crown designed to specifically mate to the gingival portion of the abutment feature or the collar of a dental implant.

In a first aspect, a pre-fabricated implant provisional crown for use with a dental implant comprising an abutment is provided. The provisional crown comprises: a hollow shell having a frontal surface, a rear surface, an occlusal or incisal surface, a mesial surface, a distal surface, and a cervical line to thereby define an exterior perimeter which substantially corresponds in shape to the exterior shape of a natural tooth; and a void defined in the interior of said hollow shell. The hollow shell is configured so as to define a void which substantially corresponds in size and shape to the abutment of the dental implant. Further, the contour of the cervical line substantially corresponds in shape to the contour of the collar of the abutment or the collar of the dental implant so as to provide a custom fit between the pre-fabricated implant provisional crown and the dental abutment or implant.

In certain embodiments, the hollow shell further comprises a margin corresponding in contour to the cervical line and extending a partial distance from the cervical line towards the occlusal or incisal surface. The margin may be preferably polished and contoured so as to provide a smooth surface to thereby facilitate gum healing.

The exterior perimeter of the hollow shell may substantially correspond in shape to the exterior shape of a natural maxillary or mandibular tooth, such as a central incisor, lateral incisor, canine, premolar, or molar tooth.

In another aspect, the invention provides methods for placement of pre-fabricated implant provisional crowns of the invention. The methods generally comprise placing an endosseous implant at a site of an edentulous ridge or extracted tooth socket in a patient in need thereof, releasably securing an implant abutment to the gingival portion of the endosseous implant; selecting a pre-fabricated implant provisional crown substantially corresponding in shape to the exterior shape of a natural tooth of a desired size and shape based upon the patient's edentulous ridge or extraction site; optionally adjusting the contacts and occlusion of the provisional crown; placing the pre-fabricated implant provisional crown of the invention over the implant abutment such that the void is mated with the implant abutment; and temporarily securing the pre-fabricated implant provisional crown on the implant abutment via application of a temporary cement or fixative to thereby temporarily mount the pre-fabricated implant provisional crown to the dental implant. In accordance with the methods of the invention, the pre-fabricated implant provisional crown is also selected based on matching the void configuration to the implant abutment, preferably within a predetermined tolerance.

In yet another aspect of the invention, a kit is provided which comprises a single crown or an assortment of pre-fabricated implant provisional crowns of the invention. The kit may include a single crown or an assortment of crowns of a variety of sizes, shapes, and shades as well as a variety of void configurations.

These and other embodiments of the present invention along with many of its advantages and features are described in more detail in conjunction with the text below and attached figures.

### BRIEF DESCRIPTION OF THE DRAWINGS

FIG. 1 illustrates a prior art provisional crown.

FIG. 2 illustrates a provisional crown of the invention.

FIG. 3 illustrates the front view of a provisional crown of the invention and an implant abutment useful in connection with the provisional crown.

FIG. 4 illustrates the rear view of a provisional crown of the invention and an implant abutment useful in connection with the provisional crown.

FIG. 5 illustrates a longitudinal view of an implant abutment useful in connection with the provisional crowns of the invention.

FIG. 6 illustrates placement of the implant abutment of FIG. 5 in a dental implant.

FIG. 7A-7E illustrates placement of a dental implant, implant abutment and provisional crown of the invention.

FIG. 8 illustrates an alternative implant abutment useful in connection with the provisional crowns of the invention.

FIG. 9 illustrates an alternative implant abutment and implant fixture useful in connection with the provisional crowns of the invention.

### DETAILED DESCRIPTION OF THE INVENTION

The invention relates in general to the fabrication of provisional or temporary crowns utilized to temporarily restore dental implants. The pre-fabricated provisional crowns are designed to specifically mate to the gingival portion of the abutment fixture or the collar of a dental implant. Therefore, the clinician can place the implant alone or in conjunction with a tooth extraction, and may select and place an abutment and a pre-fabricated provisional crown for that particular implant system in the same appointment.

In addition to providing for the fabrication and use of fixed provisional restorations in partially edentulous patients undergoing treatment with osseointegrated fixtures, this invention serves as a diagnostic aid and an adjunct in tissue healing, and provides a back-up prosthesis for maintenance and a means for immediate verification by the patient of the benefits of a tissue-integrated prosthesis.

The pre-fabricated provisional implant crown will generally comprise a hollow shell. The hollow shell may be fabricated from any suitable material known in the art compatible with the oral environment for such purposes, including polycarbonate, polymethylmethacrylate, bis-acryl, composite materials, etc. The shell will be hollow in the interior aspect in order to accommodate implant prosthetic abutment systems (i.e., Easy Abutment™ from Nobel Biocare; Solid Abutment™ from Straumann ITI, etc.). However, the present invention is generally applicable to any available implant and abutment system known in the art, and is not limited to any particular model or manufacturer. Exemplary implant/abutment systems can be found in the Straumann ITI, 2004 EAO Special Ed., STARGET Catalog; the Nobel Biocare AG, NobelEsthetic™ Product Catalog, including Procer™; and Steri-Oss Inc. IMZ/INTERPORE™ Product Catalog, September 1998, as well as many other manufacturers catalogs, each of which are herein incorporated by reference in their entirety.

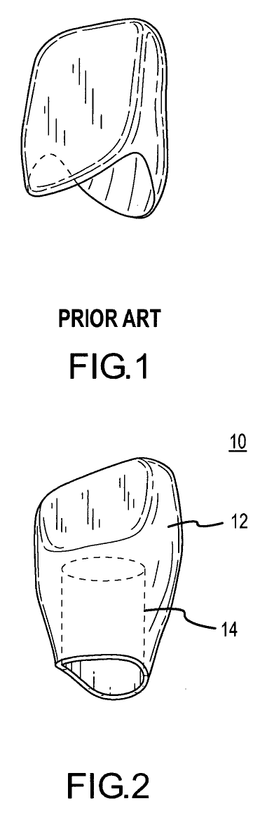

In the past, prior art provisional crowns generally included a significant hollow center which did not fit well with a dental implant (see FIG. 1). Rather, extensive use of resins, glues, cements, etc., were needed to form a contact between the crown and the implant. However, in accordance with the present invention, the hollow shell 12 of the invention is configured so as to define an interior void 14 which substantially corresponds in size and shape to the abutment of a dental implant so as to provide a custom fit between the pre-fabricated implant provisional crown 10 and the dental implant (see FIG. 2).

As mentioned above, the hollow crown shell may generally be fabricated of polycarbonate. However, other suitable materials (e.g. polymethylmethacrylate, bis-acryl, composite materials, etc.) known in the art for provisional crown applications may be used. The hollow shell will generally include a frontal surface, a rear surface, an occlusal or incisal surface, a mesial surface, a distal surface and a cervical line to thereby define an exterior perimeter. The exterior perimeter of the hollow shell will substantially correspond in shape to the exterior shape of a natural tooth. Further, the contour of the cervical line at the frontal surface of the hollow shell may be evenly contoured, generally offset from the contour of the cervical line at the rear surface of the hollow shell, to thereby more closely mimic the contour of the cervical line of a natural tooth or contoured to match the implant collar.

By way of example, the shape of the hollow shell may take the form of a natural maxillary or mandibular tooth, including a central incisor, lateral incisor, canine, premolar, or molar tooth. Further, the hollow shell may be fabricated in various sizes, shapes, and colors to match various patient anatomies.

In certain embodiments, the hollow shell will further comprise a margin corresponding in contour to the cervical line of the abutment or collar of a dental implant, and extending a partial distance from said cervical line towards the occlusal or incisal surface. The margin is preferably polished so as to provide a smooth surface to thereby facilitate gum healing.

Any dental implant system known in the art may be used in connection with the present invention. In general, the dental implant system will include a cylindrical portion that is implanted in the patients jawbone. The dental implant system also includes a temporary abutment or coping which mates with the gingival aspect of the cylindrical implant portion and extends supragingivally. The provisional implant crown of the invention is pre-fabricated to mate with such abutments or copings or to the collar of a dental implant to provide a temporary or provisional dental restoration. As used herein, abutment and coping will be used interchangeably.

This provisional crown will be fabricated to substantially fit to the prosthetic abutment of various known implant systems. The hollow shell is preferably configured such that the void corresponds in size and shape to various known implant abutments within a predetermined tolerance, In certain embodiments, the interior surface of the hollow shell defining the void will be polished and/or smooth to facilitate placement about the abutment. By way of example, in one embodiment, the hollow shell will be configured so as to define an interior void that is substantially conical or cylindrical in shape. In another embodiment, the hollow shell will be configured so as to define an interior void that is substantially hexagonal in shape.

Suitable platform openings for such, e.g., conical, cylindrical, or hexagonal voids may range from 2.5 mm to 6.0 mm, e.g., 2.5 mm, 3.3 mm, 3.5 mm, 4.0 mm, 4.1 mm, 4.3 mm, 4.8 mm, 5.0 mm, 6.0 mm etc. Suitable heights for such voids may be configured to match known implant abutment heights. If necessary, the size and shape of the provisional crown may be modified prior to placement utilizing a hand-piece, cold cure acrylic, or composite as known in the art (e.g., the proximal contacts may be modified with a hand-piece, cold cure acrylic and composite, etc., and the occlusion may be adjusted with a hand-piece, cold cure acrylic and composite, etc.).

Again, any suitable abutment known in the art may be used in connection with the provisional implant crowns of the invention. For instance, the abutment may take the form of an elongated tubular body which has a base portion adapted at a first end of the body to mate with the gingival aspect of the patient's implant fixture, and a solid or thin-walled tubular portion extending to the other end of the body supragingivally from the base portion when the base portion is so mated. In one embodiment, the base portion is generally substantially rigid, having a thicker sidewall than the thin-walled tubular portion. A shoulder may be provided within the base portion, for cooperating with a bolt to fasten the abutment to the implant fixture. Alternatively, the abutment may be formed with external threads to mate with internal threads of the implant fixture. A collar may extend radially from the abutment, preferably from the rigid base portion, for mating with the provisional crown, as described herein.

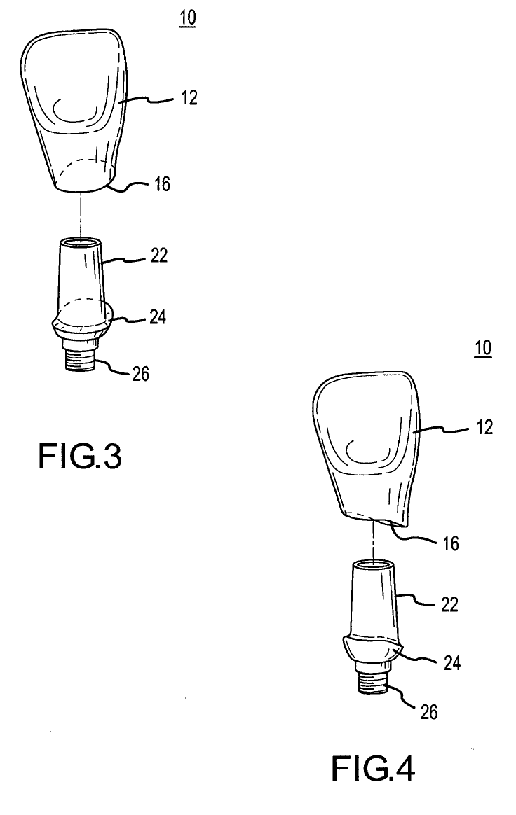

In one embodiment, with reference to FIGS. 3 and 4, the void (not shown) defined by the interior space of the hollow shell 12 of the provisional implant crown of the invention will generally be pre-fabricated in different sizes and shapes to fit different prosthetic implant abutments 22 of various implant systems (not shown). Without being limited to any particular abutment attachment mechanism, generally, as described below, the implant abutment 22 may include external threads 26 which mate with internal threads of the cylindrical body of the implant placed in the patient's jawbone (not shown). Further, in certain embodiments, the contour of the cervical line 16 of the hollow shell 12 may be formed to substantially correspond in shape to the contour of the collar 24 of the abutment 22 of the dental implant so as to provide a more precise custom fit between the pre-fabricated implant provisional crown and the dental implant.

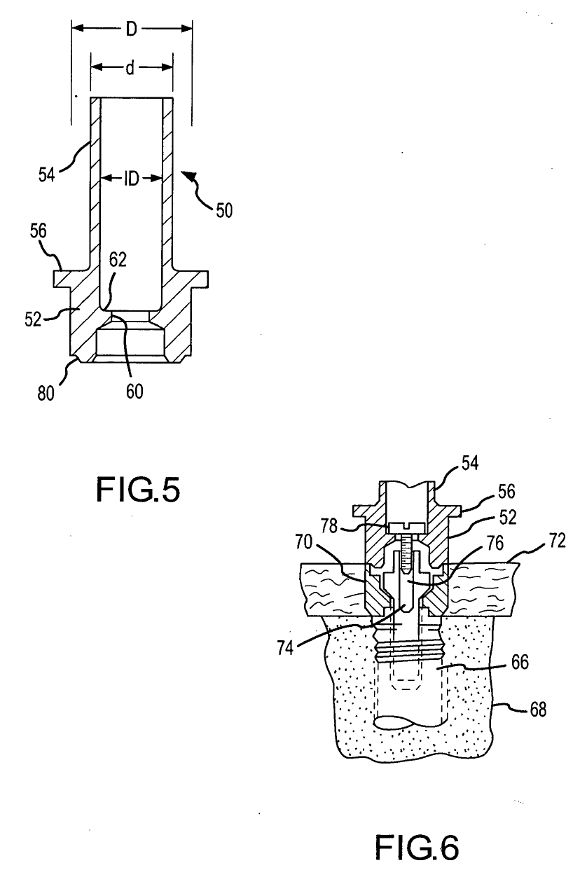

With reference to FIG. 5 an alternative abutment 50 is illustrated, generally tubular in shape, having a base portion 52 and a relatively thin-walled tubular portion 54 joined end-to-end. An annular retaining collar 56 extends radially outward from the abutment in the region where the provisional crown will mate with the abutment. The exterior diameter “D” of the base portion 52 is larger than the exterior diameter “d” of the thin-walled portion 54. The interior diameter “ID” of both portions is substantially the same. A radially-inwardly extending interior flange 60 located within the base portion 52 provides a shoulder 62 for a fastening means 78.

FIG. 6 shows an abutment fixed on a dental implant fixture 66 of a well-known type installed in a jawbone 68. A transmucosal component 70, penetrating the overlying gum tissue 72, is fixed to the implant fixture with a screw 74 the head portion of which has an internally-threaded socket 86 which receives the bolt 78 cooperating with the shoulder 62 to fix the coping 50 on the transmucosal component 70. The gingival end of the base portion 52 has an annular extension 80 which functions to mate with and center the coping coaxially on the transmucosal component 70.

Abutments may be made with a variety of materials including metals, (e.g.: palladium-silver alloy, stainless steel, aluminum, etc.) and plastic materials (e.g.: acrylics, zirconium, aluminum oxide, etc.). Other choices may be made. Any abutment material is compatible with this invention. Another consideration is to choose a material having adequate resistance to deformation on loading, for the prosthesis being contemplated.

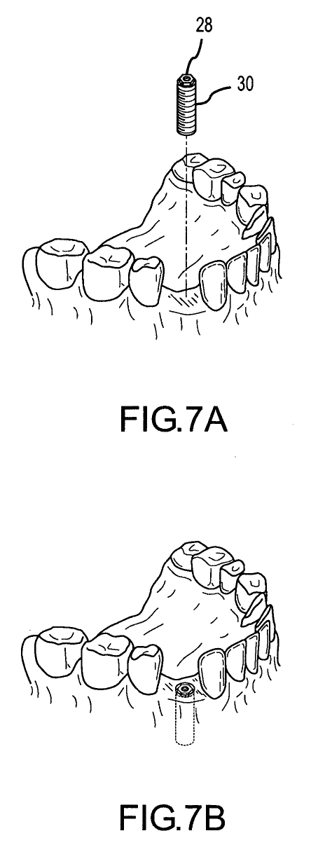

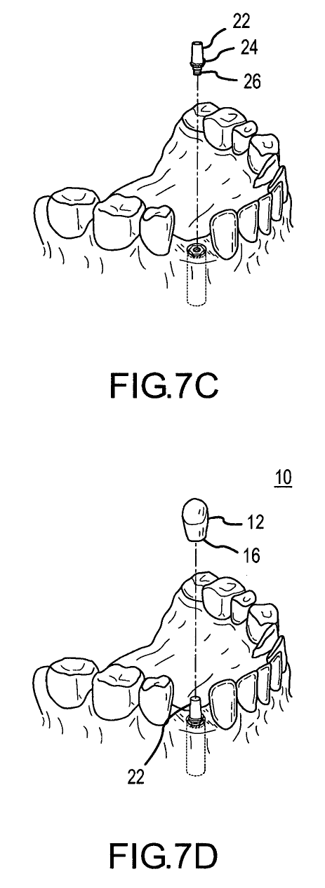

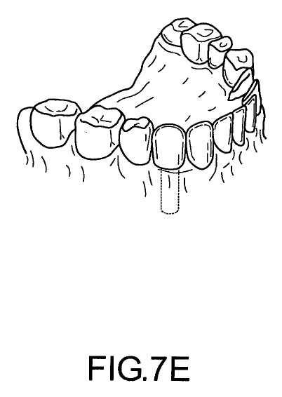

Turning to FIGS. 7A-7E, insertion of an exemplary dental implant and pre-fabricated provisional implant crown of the invention is illustrated. A widely-used form of dental implant fixture includes a generally cylindrical body 30 which is implanted in a cylindrical bore made in the patient's jawbone (i.e., an endosseous implant) at the site of a edentulous ridge or tooth extraction socket, and having an internally-threaded cylindrical socket 28 in which to fasten components used for attaching a permanent restoration to the implant fixture once the jawbone and gumline are healed. Prior to healing, abutment 22 is releasably fastened into cylindrical body 30 by screwing threads 24 into the implant socket 28. Once abutment 22 is releasably secured in place, the appropriately sized pre-fabricated implant provisional crown 10 is placed over abutment 22 such that the void is mated with abutment 22, properly adjusted (interproximally and occlusally), and the crown 10 is secured in placed using a suitable temporary dental fixative. By way of example, abutment 22 and provisional implant crown 10 may generally be left in place for period of time, e.g., 2 months, 3 months, 6 months, etc. sufficient to allow for healing of the patient's jawbone and gumline. Once healed, the provisional crown 10 and abutment 22 may be removed, and a permanent restoration put in place on the implant fixture, as known in the art.

In a preferred embodiment, crown 10 is temporarily secured to abutment 22 such that the cervical line 16 of the hollow shell 12 mates with the collar 24 of abutment 22. By way of example, a suitable temporary dental fixative or cement (not shown) may be applied between abutment 22 and the interior surface of the hollow shell forming the interior void of crown 10 to thereby temporarily secure the pre-fabricated implant provisional crown on the implant abutment. In one embodiment, at the end of the healing period, the provisional crown 10 may be removed from abutment 22 by any suitable method, as known in the art.

The pre-fabricated implant provisional crown may be selected based, in part, on the size and shape of the patient's edentulous ridge or extraction socket. For example, the crown may be selected such that the exterior perimeter of the hollow shell substantially corresponds in size and shape to the exterior of the natural tooth extracted from the patient at the edentulous space or extraction site. Further, the pre-fabricated implant provisional crown may be selected based, in part, on the size and shape of the implant abutment, e.g., selected such that the void configuration substantially corresponds in size and shape to the implant abutment. In one embodiment, the void configuration is selected to correspond to the size and shape of the implant abutment within a predetermined tolerance, as discussed above.

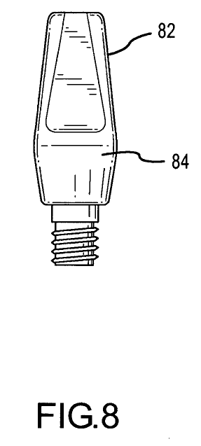

In alternative embodiments, with reference to FIG. 8, an alternative abutment 82 is shown, wherein the collar 84 is not scalloped. As illustrated, collar 84 provides a level contour. In such embodiments, the contour of the cervical line of the pre-fabricated implant provisional crown of the invention may likewise be generally level to correspond in shape to collar 84, thereby providing a custom fit between the crown and the dental implant. Exemplary abutments with such collar contours include Easy Abutment™ from Nobel Biocare.

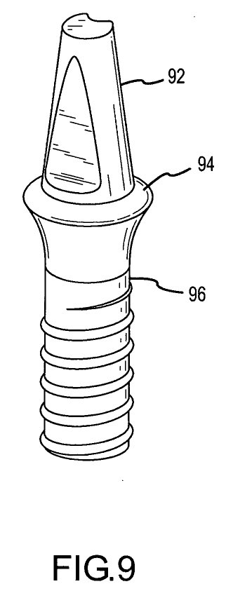

In yet other embodiments, with reference to FIG. 9, abutment 92 may be formed without a collar, and the edge of abutment 92 may interface directly with implant fixture 96.

In such embodiments, the cervical line and/or margins of the pre-fabricated provisional crowns of the present invention (not shown) will rest directly on the collar 94 of the implant fixture 96, rather than the abutment 92. Exemplary abutments and implant fixtures with such configuration are available from Straumann ITI.

In another embodiment of the invention, kits comprising a single crown or a plurality of pre-fabricated implant provisional crowns (PFEPC) described herein are also provided. The kits will generally include a single crown or an assortment of PFIPCs of predetermined sizes, shapes and shades substantially corresponding in size, shape and shade to natural teeth including maxillary and mandibular central incisors, lateral incisors, canine, premolar, and molar teeth. Further, the kits will include a single crown or an assortment of PFIPCs having a variety of void configurations generally corresponding in size and shape to the abutment of a plurality of different predetermined dental implant systems.

In certain embodiments, the kits will also include a single crown or an assortment of PFIPCs having a variety of cervical line contours substantially corresponding in shape to the contour of the collar of the abutment or the collar of the dental implant of a plurality of different predetermined dental implant systems. In this way, kits are provided which include a variety of PFIPCs to select from so as to provide a custom fit between the selected pre-fabricated implant provisional crowns and a variety of predetermined dental implant systems, thereby avoiding the need for labor-intensive customization of the provisional crown during mounting.

The kits may comprise one or more crowns with polished margins, as described above. Further, the kits may include one or more crowns configured to include conical, cylindrical and/or hexagonal shaped voids, as described above. The interior surfaces of one or more of the hollow shells forming the crowns may also be polished and /or smooth, as described above. The kits of the invention may include crowns comprising any other combination of features described herein, as recognized by those skilled in the art.

Those of ordinary skill in the art will realize that specific parameters can vary for different implant systems and materials of use without departing from the spirit of the invention. Other variations will also be apparent to persons of skill in the art. These equivalents and alternatives are intended to be included within the scope of the present invention. Therefore, the scope of this invention should not be limited to the embodiments described, but should instead be defined by the following claims.

1. A pre-fabricated implant provisional crown for use with a dental implant comprising of an abutment and an implant, said provisional crown comprising:
a hollow shell having a frontal surface, a rear surface, an occlusal or incisal surface, a mesial surface, a distal surface and a cervical line to thereby define an exterior perimeter which substantially corresponds in size and shape to the exterior size and shape of a natural tooth; and
a void defined in the interior of said hollow shell substantially corresponding in size and shape to the abutment of said dental implant;
wherein the contour of said cervical line of said hollow shell substantially corresponds in shape to the contour of the collar of the abutment of said dental implant or to the collar of said dental implant so as to provide a custom fit between said pre-fabricated implant provisional crown and said dental abutment or said dental implant, such that the pre-fabricated implant provisional crown is configured to temporarily restore said dental implant.

2. The provisional crown of claim 1, wherein said hollow shell is formed from a material selected from the group consisting of: polycarbonate, polymethylmethacrylate, bis-acryl and composite materials.

3. The provisional crown of claim 1, wherein said hollow shell further comprises a margin on the exterior surface of said hollow shell corresponding in contour to said cervical line and extending a partial distance from said cervical line towards said occlusal or incisal surface.

4. The provisional crown of claim 3, wherein said margin is polished so as to provide a smooth surface to thereby facilitate gum healing and contouring.

5. The provisional crown of claim 1, wherein the interior surface of said hollow shell defining said void is smooth to facilitate placement about said abutment or implant.

6. The provisional crown of claim 1, wherein said void is substantially conical or cylindrical in shape.

7. The provisional crown of claim 1, wherein said void is substantially hexagonal in shape.

8. (canceled)

9. The provisional crown of claim 1, wherein the contour of the cervical line is evenly contoured from the frontal surface to the rear surface, the contour of the cervical line at the frontal surface of the hollow shell is generally offset from the contour of the cervical line at the rear surface of the hollow shell, or is contoured to the collar of the dental implant.

10. The provisional crown of claim 1, wherein the exterior perimeter of said hollow shell substantially corresponds in shape to the exterior shape of a natural maxillary or mandibular tooth.

11. The provisional crown of claim 1, wherein the exterior perimeter of said hollow shell substantially corresponds in shape to the exterior shape of a central incisor, lateral incisor, canine, premolar, or molar tooth.

12. A method for temporarily mounting a pre-fabricated implant provisional crown to a dental implant, said method comprising:
placing an endosseous implant at a site of an edentulous ridge or extracted tooth socket in a patient in need thereof,
releasably securing an implant abutment to the gingival portion of said endosseous implant;
selecting a pre-fabricated implant provisional crown substantially corresponding in size and shape to the exterior size and shape of a natural tooth of a desired size, shape and shade based upon the patient's extraction site;
wherein said pre-fabricated implant provisional crown comprises a hollow shell having an exterior perimeter substantially corresponding in size and shape to the exterior size and shape of said natural tooth and a void defined in the interior of said hollow shell, and wherein said pre-fabricated implant provisional crown is further selected such that said void substantially corresponds in size and shape to said implant abutment so as to provide a custom fit between said pre-fabricated implant provisional crown and said dental implant;
placing said pre-fabricated implant provisional crown over said implant abutment such that said void is mated with said implant abutment; and
optionally adjusting the contacts or occlusion of said pre-fabricated implant provisional crown;
temporarily securing said pre-fabricated implant provisional crown on said implant abutment via application of a temporary cement or fixative to thereby temporarily mount said pre-fabricated implant provisional crown to said dental implant.

13. The method of claim 12, wherein said temporary cement or fixative is applied between said implant abutment and the interior surface of said hollow shell forming said interior void of said pre-fabricated implant provisional crown to thereby temporarily secure said pre-fabricated implant provisional crown on said implant abutment or said implant.

14. The method of claim 12, wherein said contacts or occlusion of said pre-fabricated implant provisional crown are optionally adjusted utilizing a hand-piece, cold cure acrylic, or composite.

15. The method of claim 12, wherein said pre-fabricated implant provisional crown is selected such that said void corresponds in size and shape to said implant abutment within a predetermined tolerance.

16. The method of claim 12, wherein said hollow shell is formed from a material selected from the group consisting of: polycarbonate, polymethylmethacrylate, bis-acryl and composite materials.

17. The method of claim 12, wherein said hollow shell includes a frontal surface, a rear surface, an occlusal or incisal surface, a mesial surface, a distal surface and a cervical line thereby defining an exterior perimeter, and said pre-fabricated implant provisional crown is selected such that the contour of said cervical line substantially corresponds in shape to the contour of the collar of said implant abutment or implant so as to provide a custom fit between said pre-fabricated implant provisional crown and said dental abutment or implant.

18. A kit comprising a single crown or a plurality of pre-fabricated implant provisional crowns of predetermined sizes, shapes and shades substantially corresponding in size, shape and shades of natural teeth selected from the group consisting of maxillary and mandibular central incisors, lateral incisors, canines, premolars, and molar teeth, said pre-fabricated implant provisional crowns for use with dental implants comprising an implant abutment;
wherein said pre-fabricated implant provisional crowns each comprise:
a hollow shell having a frontal surface, a rear surface, an occlusal or incisal surface, a mesial surface, a distal surface and a cervical line to thereby define an exterior perimeter which substantially corresponds in size and shape to the exterior size and shape of said natural teeth; and
a void defined in the interior of said hollow shell substantially corresponding in size and shape to the abutment of at least one predetermined dental implant system;
wherein the contour of said cervical line of said hollow shell of said pre-fabricated implant provisional crown substantially corresponds in shape to the contour of the collar of the abutment or collar of the dental implant of said at least one predetermined dental implant system so as to provide a custom fit between said pre-fabricated implant provisional crowns and said predetermined dental implant system.

19. The kit of claim 18, wherein each of said hollow shells are formed from a material selected from the group consisting of: polycarbonate, polymethylmethacrylate, bis-acryl and composite materials.

20. The kit of claim 18, wherein each of said hollow shells further comprise a margin on the exterior surface of said hollow shell corresponding in contour to said cervical line and extending a partial distance from said cervical line towards said occlusal or incisal surface.

21. The kit of claim 20, wherein said margin is polished so as to provide a smooth surface to thereby facilitate gum healing and contouring.

22. The kit of claim 18, wherein the interior surface of said hollow shells defining said void is smooth to facilitate placement about said abutment.

23. The kit of claim 18, wherein at least one of said interior void is substantially conical or cylindrical in shape.

24. The kit of claim 18, wherein at least one of said interior void is substantially hexagonal in shape.
